(19) United States
(12) Patent Application Publication
(10) Pub. No.: US 2010/0070875 A1
(43) Pub. Date: Mar. 18, 2010

(54) INTERACTIVE PROFILE PRESENTATION

(75) Inventors: Andrzej Turski, Redmond, WA (US); Shane Williams, Seattle, WA (US); Stacey Ellan Harris, Duvall, WA (US); Lili Cheng, Bellevue, WA (US); Michael Anthony Affronti, Seattle, WA (US); Owen Braun, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/207,938

(22) Filed: Sep. 10, 2008

(51) Int. Cl. G06F 3/00; G06F 17/30

(52) U.S. Cl. 715/748; 707/E17.032

(57) ABSTRACT

Techniques, systems, and graphical user interfaces for presenting an interactive profile of a second entity to a first entity in an electronic communication (e.g., email, instant messaging, chat-room, etc.) application are disclosed herein. Data associated with a second entity is extracted from one or more non-dedicated sources external to the electronic communication. The extracted data is presented to a first entity as the interactive profile of the second entity in the electronic communication application. The interactive profile is also capable of acting as an electronic communication channel through which the first and second entities may communicate.

### BACKGROUND

A social network refers to a set of entities that interact and exchange information in a social relationship. Entities include, for example, people, teams, groups, organizations, and countries, while social relationships refer to friendship, employment, common interests or other relationships between these entities.

Social networking applications are tools that help capture an entity's social network, by linking together, in a centralized manner, friends, family, colleagues, and acquaintances associated with the entity. The applications, for example, span from internet websites to applications used internally within an enterprise. Social networking at enterprises, for example, can provide people connections that are valuable for finding proper contacts and for general cross-pollination of ideas.

While there are some successful social networking solutions, particularly wed-based solutions, there is still a lack of successful social networking solutions in other arenas, such as within enterprises. The solutions that have been developed for enterprises, wherein the social networking solutions are managed within the enterprise, have been viewed as unsuccessful because they seem too remote from the ways in which employees work. Web-based solutions are often not feasible to enterprises because their security boundaries are not clearly defined, companies do not trust third-parties to have access to their secrets, they are not appropriate for work-related discussions that may mix social and confidential content, and/or the internet is not the dominate form of communication within an enterprise.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

According to a first aspect, a method for presenting an interactive profile of a second entity to a first entity in an electronic communication application is provided. The method comprises extracting data associated with the second entity from one or more non-dedicated sources (a phone, contact list, company directory, etc.) external to the electronic communication (e.g., email, instant messenger, chat-room, etc.) application to create the interactive profile of the second entity. It will be appreciated that extracted data may be supplemented with data (associated with the second entity) from dedicated sources, sources internal to the electronic communication application, and/or sources managed by the first entity (e.g., local sources accessible by the first entity). The method also comprises presenting the extracted data to the first entity as the interactive profile of the second entity in the electronic communication application. The interactive profile may also be customized (with private notes and/or tags regarding the second entity) for the first entity, for example, by supplementing the data extracted with data from sources managed by the first entity.

According to another aspect, a system for presenting an interactive profile of a second entity to a first entity in an electronic communication application is provided. The system comprises a crawler configured to acquire data associated with the second entity from one or more non-dedicated sources external to the electronic communication application and a presentation component configured to present the acquired data to the first entity as an interactive profile of the second entity in the electronic communication application. It will be appreciated that the crawler may also crawl dedicated sources and/or sources internal to the electronic communication application and supplement data extracted from the one or more non-dedicated sources external to the electronic communication application with data from dedicated and/or internal source. Crawling data internal to the first entity's electronic communication application may allow public data associated with the second entity to be combined with private data associated with the second entity (and known to the first entity), for example. The system also comprises a communication component configured to create an electronic communication channel through the interactive profile.

According to another aspect, a graphical user interface is provided. The graphical user interface comprises a multi-facetted window in an electronic communication application, wherein an interactive profile of a second entity is displayed to a first entity, the interactive profile including an image associated with the second entity and editable by the second entity. The interactive profile also includes a shared items group customized by the second entity for the first entity as a function of data transferred to the first entity from the second entity.

The techniques disclosed herein may promote social networking in an enterprise environment by providing entities (e.g., individuals) with a way to communicate and interact more personally while maintaining security. Additionally, using a current workstation and/or electronic communication application's login credentials for profile and database access allows the techniques to be implemented more easily.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of presenting an interactive profile of a second entity to a first entity in an electronic communication application.

FIG. 2 is a component block diagram illustrating an exemplary system for presenting an interactive profile of a second entity to a first entity in an electronic communication application.

FIG. 3 is an exemplary graphical user interface for presenting an interactive profile of a second entity to a first entity in an electronic communication application.

FIG. 4 is an exemplary graphical user interface for presenting an interactive profile of a second entity to a first entity in an electronic communication application in full-screen view.

FIG. 5 is an exemplary graphical user interface for presenting an interactive profile of a second entity to a first entity in an electronic communication application in folder view.

FIG. 6 is an illustration of an exemplary computer-readable medium comprising processor-executable instructions configured to embody one or more of the provisions set forth herein.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

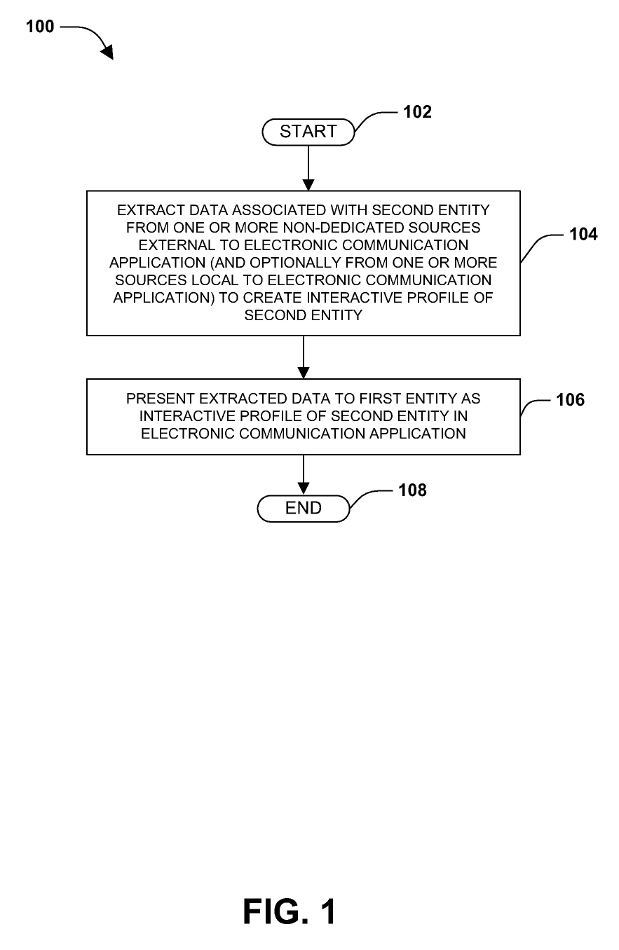

Turning initially to FIG. 1 an exemplary methodology 100 is illustrated for presenting an interactive profile of a second entity to a first entity in an electronic communication application. It will be appreciated that the terms “electronic communication application” are used in a broad sense herein to describe, among other things, an application capable of outputting data from a first entity to a second entity through an electronic communication channel and/or receiving data from the second entity through an electronic communication channel and presenting the received data to the first entity. This may include, for example, an email application, an instant messenger application, and/or a chat-room application.

The example method 100 begins at 102, and data associated with the second entity is extracted from one or more non-dedicated sources external to the electronic communication application (and optionally from one or more sources local to the electronic communication application) to create the interactive profile of the second entity at 104. It will be appreciated that the terms “non-dedicated source” are used herein in a broad sense to describe a source whose primary function is different than supplying the electronic communication application with data, and the term “external” is used herein in a broad sense to describe a source that is not part of the electronic communication application. For example, a database whose primary purpose is to supply a webpage with data would be considered a dedicated source for the webpage application and may be considered an external source if the source is not part of the webpage application. It will be appreciated that here, as elsewhere in this disclosure, “database” is used to refer to a store of data, and not to a particular computer system, software, architecture, schema, format, etc. for holding such information. The database may also comprise a plurality of replicated databases configured to store the same data for redundancy and improved performance in access, a plurality of databases configured to store different sets of data or different portions of a set of data and/or any other type of data storage mechanism (e.g., not necessarily limited to databases).

The sources may be public, private, and/or semi-private (e.g., private outside a company) and comprise, for example, local services (e.g., desktop files, electronic mailbox, an address book, personal information management system, etc.), digital libraries, profile services (e.g., directories and profiles maintained on a company's servers), information sharing spaces (e.g., a wiki, a message board, etc.), external networking services (e.g., internet pages wherein a user has defined a social network and/or created a profile), information systems (e.g., network space, network drives, etc.), search results (e.g., from company intranet, public internet, etc.), relationship (e.g., colleague) services, and/or personal devices (phones, personal digital assistants, etc.). It will be understood in the art that the sources disclosed herein represent an exemplary set of sources and that other types of sources have also been contemplated.

The extracted data may comprise, for example, data related to a graphical representation of the second entity, data that describes the second entity and/or personal details of the second entity (e.g., name, address, phone, etc.), other entities commonly associated with the second entity (e.g., friends, colleagues, or members), and/or calendar entries of the second entity. It will be appreciated that the data extracted may be limited as a function of security boundaries, protocols, etc. For example, the second entity may have to grant access to the one or more sources before data can be extracted and/or access may be limited as a function of access credentials (e.g., in a workplace environment) of the entity intending to create the interactive profile and/or view the interactive profile. If access credentials are stored locally on the workstation, for example, third-parties may not have access to the credentials, further promoting security. Data encryption is a further security measure that may be implemented to protect private data.

Data may be extracted as a function of an entity's input. For example, the data associated with the second entity may be extracted when the first entity views an email from the second entity. In another example, data associated with the second entity is extracted when an entity (e.g., the second entity, an entity's employer, etc.) selects which sources to extract data from to create the interactive profile. The data may be extracted from the one or more sources using crawlers (e.g., a program or automated script which browses data in a methodical, automated manner), for example, that extract the data from the one or more non-dedicated sources external to the electronic communication application. It will be appreciated that data associated with the second entity may also be extracted from dedicated sources and/or sources that are internal to the electronic communication application (e.g., local sources) and used to supplement the data extracted from the one or more non-dedicated sources external to the electronic communication application.

The extracted data is used to create the interactive profile of the second entity. An interactive profile may be created, for example, by arranging the extracted data into predetermined categories of profile information (e.g., description of second entity, personal details about the second entity, etc.). In one embodiment, the data is determined to be related to a predetermined category based on an identification tag extracted with the data. For example, if the extracted data is from a network directory, the network directory may include a “name” field and a “phone number” field, wherein the data comprised within that field is tagged as being an entity's name and phone number, respectively, and categorized accordingly when it is extracted from the network directory and used to create the interactive profile. In another embodiment inference algorithms, designed using machine learning, natural language processing, and/or artificial intelligence, for example, may be used to determine the type of data extracted. In one example, the data extracted includes calendar entries, and the inference algorithms are used to determine the projects that the second entity is working on. It will be understood to those skilled in the art that other techniques may also be used to arrange the data into the second entity's interactive profile.

It will be appreciated that the interactive profile that is created may be a global profile (e.g., a profile capable of being accessed by a plurality of entities at different times and/or locations) that is stored in a network accessible database, for example. Creating a global profile may reduce the number of times data is extracted (since data extraction would not be a function of an entity viewing communication from the second entity) and therefore may reduce the resources used to create the profile, for example. In one embodiment, an enterprise initially creates the profiles (using data extracted from a company directory, shared file space, existing social network applications, etc.) for its employees to encourage camaraderie within the enterprise, for example, and stores the interactive profiles on an enterprise server. When a first entity (e.g., employee) views an email sent from a second entity (e.g., employee), for example, the interactive profile of the second entity is retrieved from the company server and presented to the first entity. It will be appreciated that data comprised in a source that is associated with the first entity (e.g., accessible by access credentials of the first entity but not by other entities) such as data stored on the first entity's workstation (e.g., desktop computer) may be used to customize the global profile when it is viewed by the first entity. For example, a desktop application may comprise notes, tags, and/or reminders related to the second entity (e.g., information about the second entity's birthday, his kids' names, etc.) that may be displayed in the interactive profile when the first entity views the second entity's interactive profile.

At 106, the extracted data is presented to the first entity as an interactive profile of the second entity in the electronic communication application. An interactive profile, as used herein, is a profile that is modifiable and provides a communication channel (apart from the communication channel comprised in the electronic communication application) through which the first entity and second entity may communicate. The interactive profile may comprise information about the second entity such as the second entity's picture/logo, personal details (name, address, phone, etc.), recent activities of the entity, a status message, a self-description, a public wall (wherein the first entity and other entities may communicate with the second entity), and/or links important to the second entity (such as a website, a wiki page, etc.) The interactive profile may also comprise, for example, a place for the first entity to comment on and/or tag data in the second entity's profile. For example, the first entity may upload pictures from a company picnic and tag photos corresponding to the second entity so that the tagged photos appear on the second entity's interactive profile.

The second entity's interactive profile and/or a portion of the interactive profile (e.g., a graphical representation of the second entity) is presented to the first entity within the electronic communication application. An event trigger (e.g., user request) may cause the second entity's interactive profile to be presented to the first entity and/or the interactive profile may be automatically presented when the electronic communication application initially launched or otherwise instantiated. For example, the interactive profile may be presented when the first entity conducts a search (by inputting searchable terms into a search field of the electronic communication application) and interactive profiles of relevant entities may be presented. In another example, the interactive profile is presented when the second entity communicates with the first entity, such as through an email message or an instant messenger message.

The interactive profile may be modified as a function of the second entity's input. In one embodiment the second entity may view the interactive profile (such as when it is stored in a database) and change his/her/its picture/logo, change his/her/its status, and/or modify the text of the interactive profile. It will be appreciated that where algorithms are used to create the interactive profile, changes by the second entity may be used to train the algorithms (and promote more accurate inferences). In another embodiment, the second entity may link private data to the interactive profile. For example, the second entity's interactive profile may be created using public information and private information known to the second entity's employer, and the second entity may link the interactive profile to a social networking profile of the second entity comprised in a web service. The web service may be crawled, and data extracted from it may be used to supplement the existing interactive profile (making the profile more personal). It will be appreciated that modifications the second entity makes to his/her/its interactive profile may also cause the data in the data sources to change. For example, the second entity may update his phone number in the interactive profile and a company directory may automatically be updated to reflect that change.

In yet another embodiment, the second entity may indirectly modify information in the second entity's interactive profile by modifying the information in the one or more non-dedicated sources. For example, if data used to create the second entity's interactive profile was extracted from a company directory, and the second entity updates the company directory, the interactive profile may be modified to reflect the update in the company directory. In one example, pings from the company directory may notify crawlers of the event (e.g., the update) and the crawlers may recrawl the company directory to collect the updated data that is used to modify the second entity's interactive profile.

The interactive profile may also be modified as a function of input from the first entity. For example, the interactive profile may include a message field, wherein the first entity may input a message for the second entity. If a global profile was created, this message may be added to the global profile so that other entities that view the second entity's interactive profile may also view the first entity's input. However, the visibility of the first entity's input may also be limited to the second entity. It will be appreciated that the second entity may limit the ability to write messages, for example, and/or modify/remove the messages that are written.

In yet another embodiment, the interactive profile may be capable of receiving a file (e.g., document, image, etc.) input by the first entity and sharing the file with the second entity. For example, the first entity may drag-and-drop a document into the second entity's interactive profile (e.g., granting the second entity access to the document). In one example, the file being shared is copied to a folder (on a server) accessible by the second entity (using the second entity's credentials) when the first entity drags-and-drops the file into the second entity's interactive profile. Since access is limited to those having the credentials of the second entity, for example, other entities may not view the file, promoting file protection. Additionally, it may be more secure than emailing an attachment, for example, because access to the file is controlled by the first entity (e.g., the first entity may later deny the second entity access to the file). It will be appreciated that first entity may share a file with a plurality of entities at once (e.g., selecting the respective entities' interactive profiles and inserting the file).

The first and/or second entity may receive notifications about changes made to the second entity's interactive profile. For example, the first entity may receive a notification when the second entity modifies his/her/its interactive profile. A notification may be sent instantaneously when a change is made and/or periodically. In one example, the first entity receives an email containing information about modifications made to the interactive profiles of his friends (e.g., those whom he corresponds with frequently) within the past day. Additionally, the second entity may receive notifications, for example, when an entity sends the second entity a message and/or shares a file with the second entity.

Supplementing data extracted from non-dedicated sources external to the electronic communication application with data in the electronic communication application, such as data regarding past communications between the first entity and the second entity and/or private data regarding the second entity that is stored locally in the first entity's electronic communication application, for example, may provide a more personalized and detailed profile of the interactions between the first and second entities. The second entity's interactive profile may be personalized for the first entity, for example, as a function of previous communications between the first and second entity. For example, the second entity's interactive profile may comprise data pointing to files that that second entity has shared with the first entity (through email attachments, files input into the first entity's interactive profile from the second entity, files stored on a database accessible by a division of a company that the first entity is a member of, etc.). The interactive profile may also comprise data pointing to conversations (email messages, instant messenger logs, etc.) between the first entity and the second entity. It will be appreciated that the personalized data displayed may be a function of the size of the interactive profile and limited according to some criteria (e.g., files that can be opened by a particular program, more recent communications, etc.).

It will be appreciated that data presented in the second entity's interactive profile and/or the contextual presentation of the interactive profile may vary as a function of the electronic communication application and/or user input. For example, the interactive profile may be presented as a side pane, popup window, separate on-screen window, dedicated area in the sidebar, etc., and the data presented may be a function of the size of the interactive profile (e.g., how much text can fit inside the pane/window). Additionally, the interactive profile may expand and/or collapse. For example, a graphical representation of the second entity may be displayed, and the user may focus on the graphical representation, causing addition data to be presented in the interactive profile. The method ends at 108.

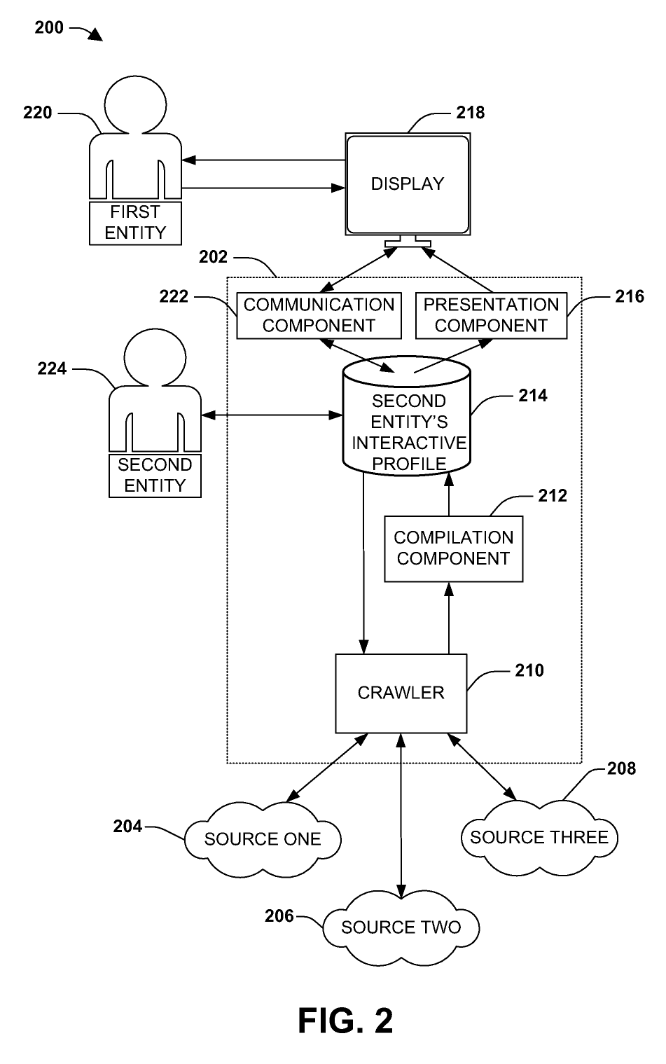

FIG. 2 illustrates an exemplary environment 200 wherein a system 202 for presenting an interactive profile of a second entity to a first entity 220 in an electronic communication application. The system 202 comprises a crawler 210 configured to acquire data associated with the second entity from one or more non-dedicated sources 204, 206, and 208 external to the electronic communication application (e.g., email application, instant messaging application, etc.), a presentation component 216 configured to present the acquired data to the first entity 220 as an interactive profile of the second entity in the electronic communication application, and a communication component 222 configured to create a communication channel between the first entity 218 and the second entity 224 through the second entity's interactive profile.

The crawler 210 collects data associated with the second entity from the one or more non-dedicated data sources 204, 206, and 208 external to the electronic communication application upon the occurrence of some event (e.g., the second entity selects to extract data, the second entity's employer selects to create interactive profiles for its employees, the first entity selects to view the second entity's interactive profile, etc.). It will be appreciated in that art that the term “crawler” is used in a broad sense herein to describe or comprise a program and/or automated script which browses one or more data sources and collects data. The one or more non-dedicated data sources 204, 206, and 208 may comprise private sources (e.g., access limited to the entity viewing the second entity's interactive profile and/or access limited to the second entity), semi-private sources (e.g., access limited to a group of entities), and/or public sources (e.g., unrestricted access). Sources may include, for example, local services (e.g., desktop files, electronic mailbox, an address book, etc.), digital libraries, profile services (e.g., directories and profiles maintained on a company's servers), information sharing spaces (e.g., a wiki, a message board, etc.), external networking services (e.g., internet pages wherein a user has defined a social network and/or created a profile), information systems (e.g., network space, network drives, etc.), search results (e.g., from company intranet, public internet, etc.) and/or personal devices (phones, personal digital assistants, etc.). It will be appreciated that the one or more non-dedicated data sources 204, 206, and 208 used to extract data and/or the data extracted may be limited as a function of security access (as a function of an entity's credentials), permissions by the entity managing the data source, etc.

In one embodiment, the crawler 210 may recrawl the one or more non-dedicated data sources 204, 206, and 208 when data in the one or more non-dedicated data sources 204, 206, and 208 have been altered (to update previously acquired data). The crawler 210 may detect that the data has been altered (e.g., by being notified of the change and/or by noticing the change during a scheduled crawl) and recrawl the altered data source automatically. Alternatively, the crawler may recrawl the one or more non-dedicated data sources 204, 206, and 208 as a function of user input (e.g., an entity tells the crawler to recrawl the data source). In one example an automated notification component monitors for pings (that indicate a change in content) from the one or more non-dedicated data sources 204, 206, and 208 and the notification component notifies the crawler 210 to crawl the one or more non-dedicated data sources 204, 206, 208 that have been altered and acquire the altered data. It will also be appreciated that the crawler may recrawl data sources in real time in response to an event, such as when an entity selects to view the second entity's profile. That is, the crawler may recrawl data whenever the profile is viewed, thus promoting an up-to-date profile of the second entity.

The data extracted by the crawler 210 may be compiled by a compilation component 212 configured to arrange the acquired data into the interactive profile of the second entity. In one embodiment, the compilation component 212 separates the data extracted into predetermined categories of data that may be displayed as the interactive profile. The predetermined categories may include, for example, contact information, recent activities of the second entity, the second entity's status, personal interest of the second entity, projects that second entity is working on, etc. Data may be separated based on tags extracted with the data and/or using inference algorithms (designed using machine learning, artificial intelligence, natural language processing techniques, etc.) that infer information from the acquired data. For example, inference algorithms may infer projects the second entity is working on as a function of calendar entries of the second entity and recently published/shared documents related to the second entity. The data compiled may be stored in a database 214 and retrieved be the presentation component 216.

It will be appreciated that interactive profile created may be a global profile (e.g., viewable by a plurality of entities). This may be useful, for example, in an enterprise setting, wherein the second entity's employer creates interactive profiles for its employees. If a global profile is created, the global profile may be customized as a function of data sources controlled by the first entity (e.g., with access limited to the first entity) and/or previous communications between the first entity and the second entity. In one example, data from a contact entry on a local service (managed by the first entity) is used to supplement the data in the global profile (e.g., by extracting the data from the local data source when the first entity views the second entity's global profile). In another example, links to emails and files the second entity has previously sent to the first entity are displayed when the first entity views the second entity's interactive profile.

In one embodiment, the second entity 224 may modify the interactive profile (by accessing the database 214) and/or add additional sources to extract data from. For example, the second entity 224 may have the crawler 210 crawl his/her/its existing social network on a web service to make his/her/its interactive profile more personal. It will be appreciated that if the second entity 224 modifies (e.g., updates contact information, creates a status message, etc.) his/her/its interactive profile, the modifications may be used to update the data in that one or more non-dedicated sources 204, 206, and 208 (e.g., to reflect the changes made in the interactive profile).

Upon the occurrence of some event in the electronic communication application, the presentation component 216 presents the acquired data to the first entity 220 (through a display 218) as the interactive profile of the second entity in the electronic communication application. This may include, for example, presenting the second entity's interactive profile when the electronic communication application opens, when the first entity 220 conducts a search of entities' interactive profiles using a search field in the electronic communication application, when the first entity 220 views data (e.g., an email) sent by the second entity, and/or when the first entity 220 sends data (e.g., an email, an instant message, etc.) to the second entity through the electronic communication application. It will be appreciated that the second entity's interactive profile may be presented in an expanded/collapsed form and/or in a variety of presentation styles within the electronic communication application, such as a side pane, pop-up window, separate on-screen window, etc.

The first entity 220 may communicate to the second entity 224 through the communication component 222 comprised within the system 202. For example, the first entity 220 may input a message into a message field on the interactive profile, wherein the message may be displayed to the second entity 224 and/or other entities that view the second entity's interactive profile. Additionally, the first entity 220 may send files (e.g., images, word processor documents, etc.) to the second entity 224 through the communication component 222. For example, the first entity 220 may drag-and-drop a picture into the second entity's interactive profile (e.g., granting the second entity 224 access to view/edit the file).

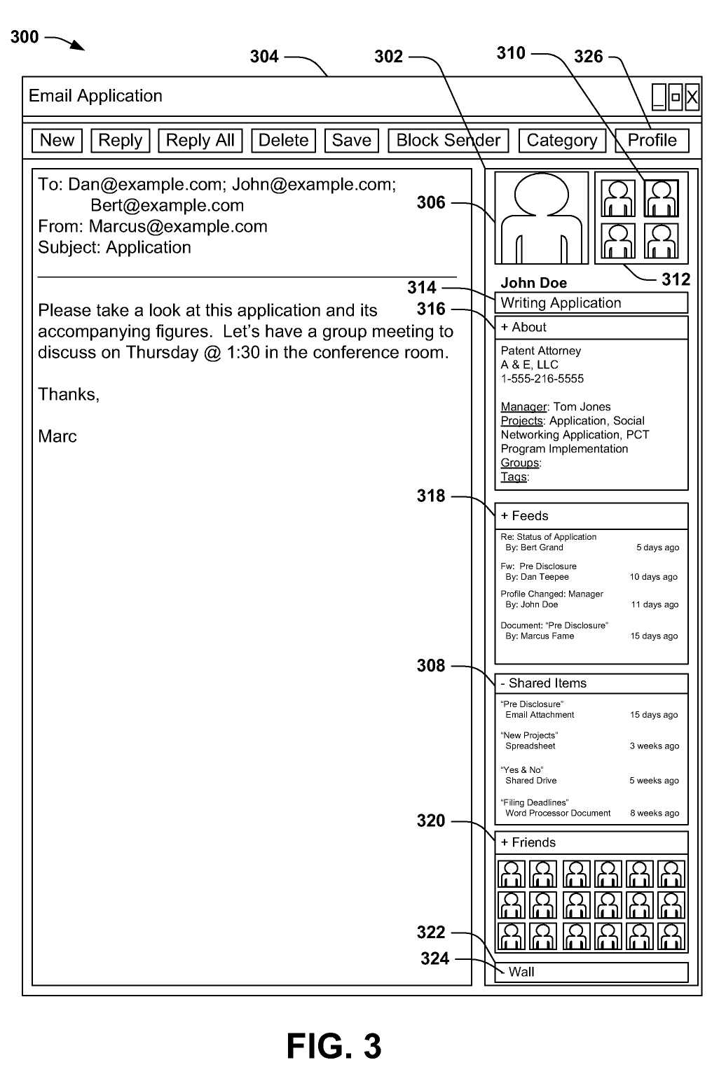

FIG. 3 illustrates an exemplary graphical user interface 300 comprising a multi-facetted window 302 in an electronic communication application 304, where an interactive profile of a second entity is displayed to a first entity. The interactive profile includes an image 306 associated with the second entity and editable by the second entity. The interactive profile also include a shared items group 308 customized by the second entity for the first entity as a function of one or more files transferred to the first entity from the second entity. The interactive profile may also comprise a component that graphically renders the profile of the second entity in an emphasized manner or a de-emphasized manner based on the first entity focusing or de-focusing, respectively, on the second entity's interactive profile. In the graphical user interface 300, the emphasized interactive profile is represented by a darker line 310 (relative to the deemphasized interactive profiles).

The electronic communication application 304 may be, for example, an email application, an instant messenger application, a chat-room application, and/or another type of application that utilizes an electronic communication channel to promote communications between the first entity and the second entity. It will be appreciated that the term “multi-facetted” is used in a broad sense herein to describe, among other things, a window capable of having a variety of views, including, but not limited to: a side pane; popup window; separate on-screen window; and/or dedicated area in the sidebar of the electronic communication application.

In the illustrated interface 300, the second entity's interactive profile is presented when the first entity views an email that has been sent by and/or includes the second entity as a recipient. It will be appreciated that interactive profiles of other entities, also included in the email, may be displayed through graphical representations 312, for example. The first entity may view a third entity's interactive profile, for example, by focusing on the graphical representation of the third entity, causing the third entity's interactive profile to be emphasized and the second entity's interactive profile to be deemphasized (e.g., causing the second entity's interactive profile to collapse).

The image 306 is modifiable by the second entity. In one example, the image 306 is modified when the second entity modifies the image 306 in a data source used to build the interactive profile, and the modified image is extracted from the data source (e.g., using crawlers). In another example, the image 306 is modified when the second entity uploads a new image directly to the interactive profile, wherein the new image replaces the image 306. If the second entity chooses not to include an image 306 in the interactive profile, the first entity may assign a graphical representation to the second entity's profile, for example. The graphical representation may be, for example, a picture associated with the second entity and/or a general graphical representation of a group, team, etc. the second entity belongs to. The assigned graphical representation may be visible to the first entity, for example, but not other entities that view the second entity's profile.

The shared items group 308 comprises files that have been transferred from the second entity to the first entity. The second entity may transfer files, for example, by attaching the file to an electronic communication (e.g., an email attachment), moving the file to a network storage accessible by the first entity, and/or dragging-and-dropping the file into an interactive profile of the first entity. It will be appreciated that the files displayed may be ranked according to some criteria, such as how recently the files were shared with the first entity. It will also be appreciated that the number of files displayed in the shared items group may be a function of the available space within the multi-facetted window 302.

The interactive profile may also include items, such as a status field 314, a personal details field 316, a self-description field, a profile feeds field 318, a field for displaying some of the second entity's friends/contacts 320, and/or a message field 322. The status field 314 may comprise, for example, a modifiable message written by the second entity and/or a message regarding the second entity's current status as a function of information extracted from his/her/its calendar. The personal details field 316 may comprise, for example, modifiable contact information and/or other commonly known personal information about the second entity, such as the projects the second entity is working on, his/her/its supervisor, etc. The self-description field may comprise, for example, more personal (than the information in the personal details field 316), modifiable information that the second entity chooses to reveal (such as his/her/its biography). The profile feeds field 318 may comprise, for example, information about recent updates the second entity has made to his/her/its interactive profile and/or comprise more recent communications (relative to other communications) between the first entity and the second entity, such as emails the first entity has received from the second entity. The field for displaying the second entity's friends/contacts 320 may comprise, for example, interactive profiles (represented through a graphical representation) of other entities the second entity communicates with. The order of the interactive profiles may be arbitrary, ranked as a function of the second entity's input, and/or ranked as a function of some criteria (e.g., according to the frequency of contact between the friend/contact and the second entity, the probability that the first entity will know the second entity's friend/contact, etc.), for example. The message field 322 may comprise, for example, a field wherein the first entity may post messages to the second entity's interactive profile. The messages may be displayed publically (so that other entities that view the second entity's interactive profile will see the message) and/or privately (so that access to the message is limited to the second entity and/or a segment of the entities capable of viewing the second entity's interactive profile). It will be appreciated that the second entity may delete messages in the message field 322 and/or write messages to the message field 322. It will be understood to those skilled in the art that other information and/or fields may also be presented in the multi-facetted window 302. For example, a field for uploading images of the second entity and/or images of projects the second entity is working on may be included in the interactive profile.

It will be appreciated that the fields displayed may be collapsed and/or expanded as a function of size limitations of the multi-facetted window and/or user input. For example the message field 322 may be expanded by selecting the “-” symbol 324. The fields may also be collapsed and/or expanded automatically, for example, based on the presence of meaningful or useful data (possibly employing some artificial intelligence algorithms). For example, the personal details field 316 may be automatically collapsed if the second entity is the first entity's friend, since the first entity may already know this information (e.g., displaying it would be superfluous). It will also be appreciated that the first entity may cause the multi-facetted window to appear and disappear (e.g., by selecting a “profile” button 326)

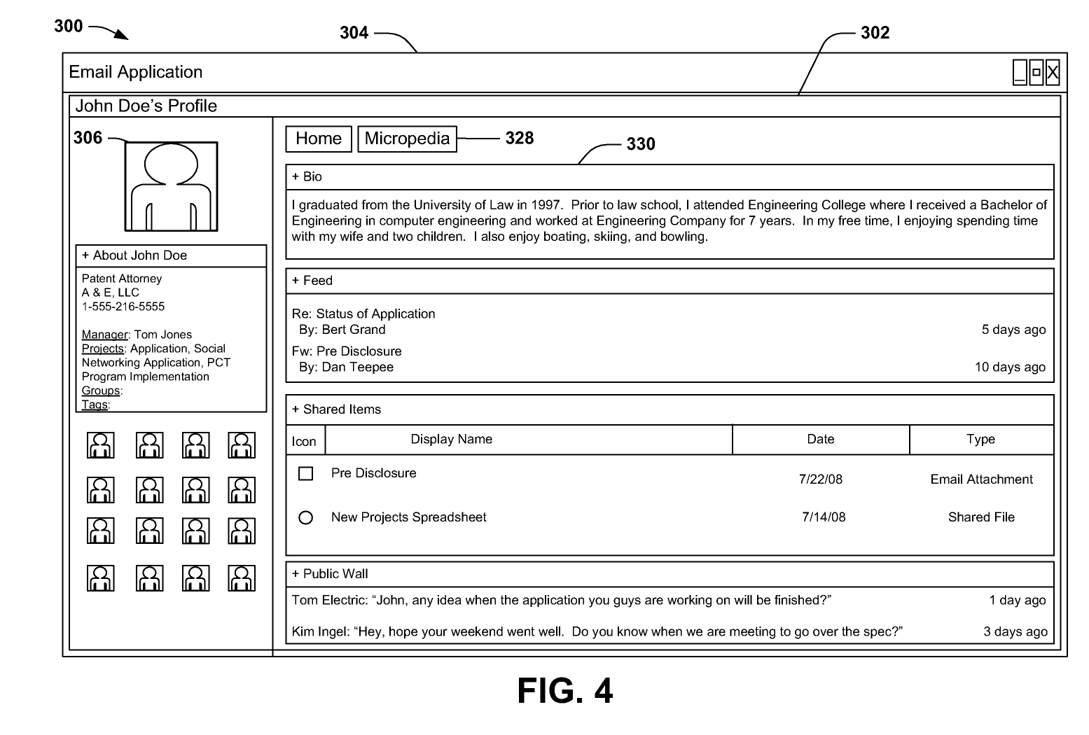

FIG. 4 illustrates the exemplary graphical user interface 300 comprising an expanded view of the multi-facetted window 302 in the electronic communication application 304. In one embodiment, the first entity expands the multi-facetted window 302 by right-clicking on the image 306 and selecting a “full-screen” option. The interactive profile may be expanded to the size of a display (used to present the electronic communication application to the first entity) and/or the size of the electronic communication application.

It will also be appreciated that the content of the interactive profile, and/or the layout of the interactive profile may change as a function of the size of the multi-facetted window 302. For example, in FIG. 4, a link 328 to another source that contains information about the second entity is displayed in the interactive profile. Additionally, a biography of the second entity 330 (e.g., the second entity's self-description) is included in the interactive profile.

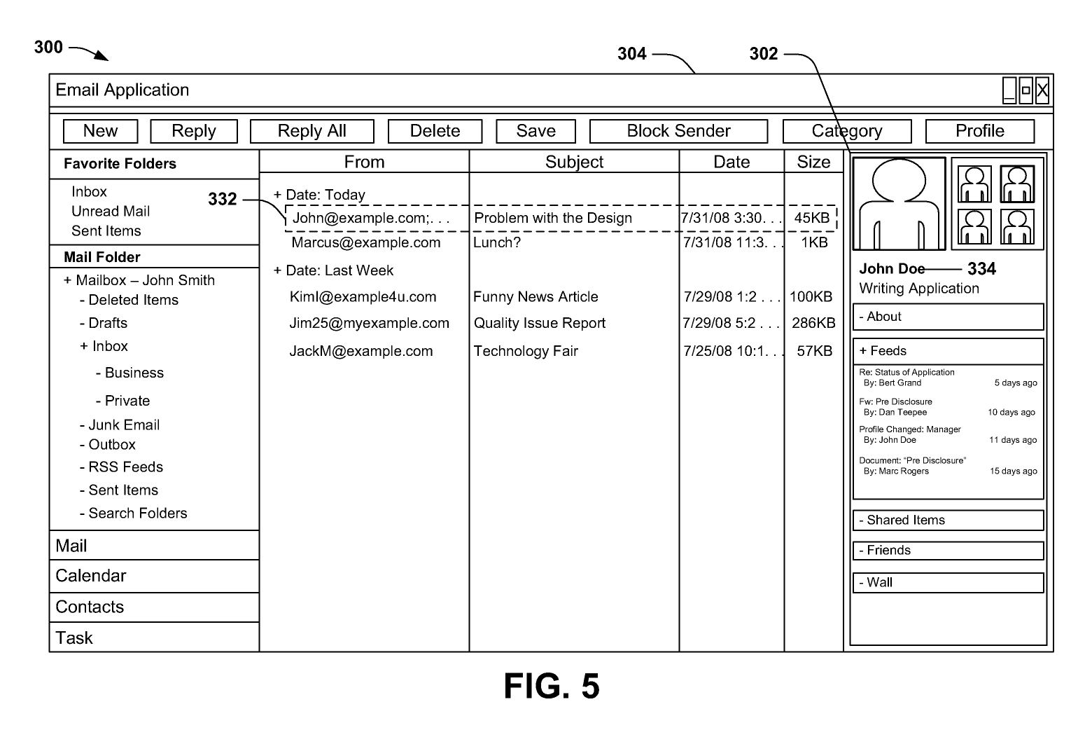

FIG. 5 illustrates the exemplary graphical user interface 300 comprising a folder view of the multi-facetted window 302 in the electronic communication application 304. A folder view, for example, allows the interactive profile to be displayed when the first entity focuses on, but does not select a communication involving the second entity. For example, the first entity may focus on an email sent by John Doe 332, and the interactive profile of John Doe 324 may be displayed in the folder view. The first entity may scroll through the communications in a folder, and/or change folders, and the interactive profile displayed may be a function of the focused on communication within the folder being viewed, for example.

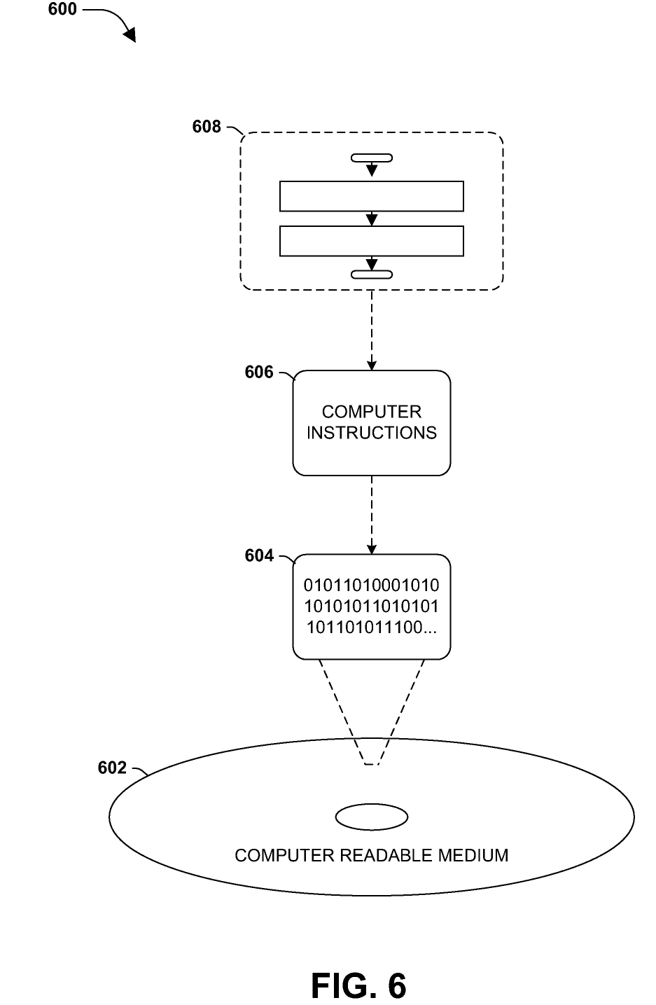

Still another embodiment involves a computer-readable medium comprising processor-executable instructions configured to implement one or more of the techniques presented herein. An exemplary computer-readable medium that may be devised in these ways is illustrated in FIG. 6, wherein the implementation 600 comprises a computer-readable medium 602 (e.g., a CD-R, DVD-R, or a platter of a hard disk drive), on which is encoded computer-readable data 604. This computer-readable data 604 in turn comprises a set of computer instructions 606 configured to operate according to one or more of the principles set forth herein. In one such embodiment 600, the processor-executable instructions 606 may be configured to perform a method, such as the exemplary methods 100 of FIG. 1, for example. In another such embodiment, the processor-executable instructions 606 may be configured to implement a system, such as the exemplary system 202 of FIG. 2, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

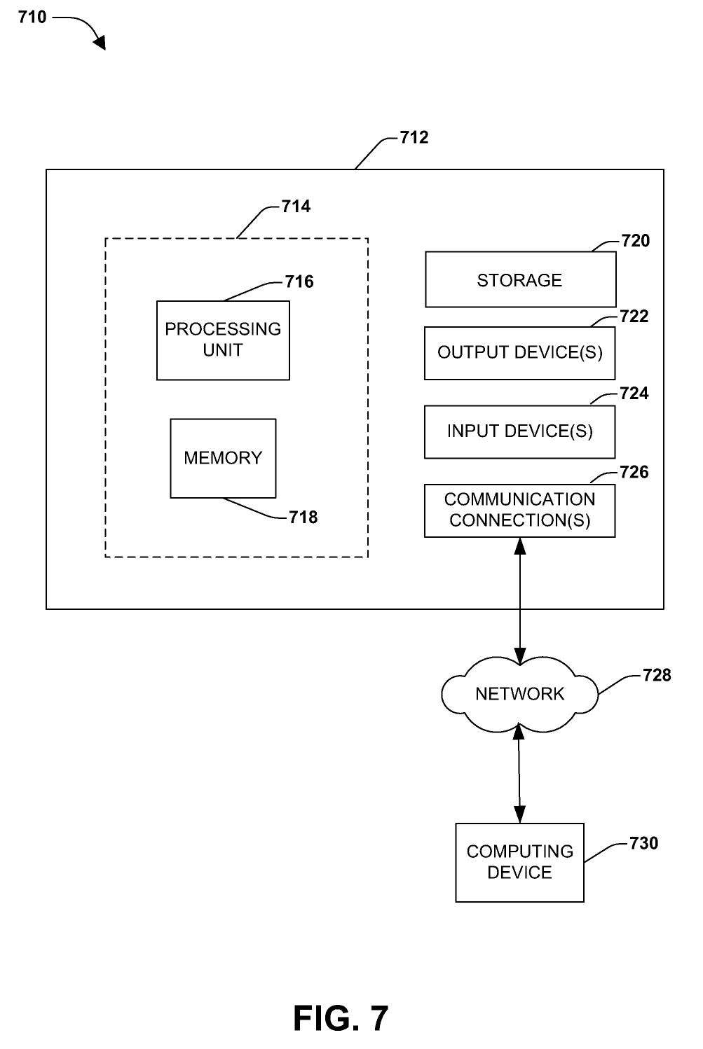

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 710 comprising a computing device 712 configured to implement one or more embodiments provided herein. In one configuration, computing device 712 includes at least one processing unit 716 and memory 718. Depending on the exact configuration and type of computing device, memory 718 may be volatile (such as RAM, for example), non-volatile (such as ROM, flash memory, etc., for example) or some combination of the two. This configuration is illustrated in FIG. 7 by dashed line 714.

In other embodiments, device 712 may include additional features and/or functionality. For example, device 712 may also include additional storage (e.g., removable and/or non-removable) including, but not limited to, magnetic storage, optical storage, and the like. Such additional storage is illustrated in FIG. 7 by storage 720. In one embodiment, computer readable instructions to implement one or more embodiments provided herein may be in storage 720. Storage 720 may also store other computer readable instructions to implement an operating system, an application program, and the like. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Any such computer storage media may be part of device 712.

Device 712 may also include communication connection(s) 726 that allows device 712 to communicate with other devices. Communication connection(s) 726 may include, but is not limited to, a modem, a Network Interface Card (NIC), an integrated network interface, a radio frequency transmitter/receiver, an infrared port, a USB connection, or other interfaces for connecting computing device 712 to other computing devices. Communication connection(s) 726 may include a wired connection or a wireless connection. Communication connection(s) 726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 712 may include input device(s) 724 such as keyboard, mouse, pen, voice input device, touch input device, infrared cameras, video input devices, and/or any other input device. Output device(s) 722 such as one or more displays, speakers, printers, and/or any other output device may also be included in device 712. Input device(s) 724 and output device(s) 722 may be connected to device 712 via a wired connection, wireless connection, or any combination thereof. In one embodiment, an input device or an output device from another computing device may be used as input device(s) 724 or output device(s) 722 for computing device 712.

Components of computing device 712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 712 may be interconnected by a network. For example, memory 718 may be comprised of multiple physical memory units located in different physical locations interconnected by a network.

Those skilled in the art will realize that storage devices utilized to store computer readable instructions may be distributed across a network. For example, a computing device 730 accessible via network 728 may store computer readable instructions to implement one or more embodiments provided herein. Computing device 712 may access computing device 730 and download a part or all of the computer readable instructions for execution. Alternatively, computing device 712 may download pieces of the computer readable instructions, as needed, or some instructions may be executed at computing device 712 and some at computing device 730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for presenting an interactive profile of a second entity to a first entity in an electronic communication application, comprising:
extracting data associated with the second entity from one or more non-dedicated sources external to the electronic communication application to create the interactive profile of the second entity; and
presenting the extracted data to the first entity as the interactive profile of the second entity in the electronic communication application.

2. The method of claim 1, the electronic communication application comprising at least one of the following:
an email application;
an instant messenger application; and
a chat-room application.

3. The method of claim 1, the one or more external sources comprising at least one of the following:
an internet website;
an electronic communication application different from the electronic communication application wherein the interactive profile is presented;
a personal information management system;
an electronic document;
a database on a network; and
a mobile cellular communications device.

4. The method of claim 1, comprising supplementing the data extracted from the one or more external sources with data extracted from the electronic communication application wherein the interactive profile is presented.

5. The method of claim 1, where the data extracted from the electronic communication application comprises at least one of data regarding previous communications between the first and second entity and private data regarding the second entity that is known to the first entity.

6. The method of claim 1, comprising using the interactive profile to share files from the first entity with the second entity.

7. The method of claim 1, comprising combining private and public data associated with the second entity to create the interactive profile, wherein the private and public data is extracted from the one or more non-dedicated sources external to the electronic communication application.

8. The method of claim 1, comprising again extracting and presenting when a predetermined event occurs.

9. The method of claim 1, wherein the second entity may modify the interactive profile presented to the first entity.

10. The system of claim 9, comprising notifying the first entity when the second entity makes a change in the interactive profile of the second entity.

11. The method of claim 9, comprising updating the one or more data sources as a function of modifications in the second entity's interactive profile.

12. The method of claim 1, comprising customizing the second entity's profile based on the data extracted from one or more sources associated with the first entity.

13. The method of claim 1, the interactive profile created being a global profile accessible by a plurality of entities.

14. A system for presenting an interactive profile of a second entity to a first entity in an electronic communication application, comprising:
a crawler configured to acquire data associated with the second entity from one or more non-dedicated sources external to the electronic communication application;
a presentation component configured to present the acquired data to the first entity as the interactive profile of the second entity in the electronic communication application; and
a communication component configured to create a communication channel through the interactive profile.

15. The system of claim 14, the communication component configured to transfer a file from the first entity to the second entity by making the file discoverable and available on demand.

16. The system of claim 14, comprising a compilation component configured to arrange the acquired data into the interactive profile of the second entity.

17. The system of claim 16, comprising a storage component configured to store the interactive profile, wherein the profile is retrieved from the storage component by the presentation component when an event associated with the first entity occurs.

18. A graphical user interface comprising:
a multi-facetted window in an electronic communication application, wherein an interactive profile of a second entity is displayed to a first entity, the interactive profile including an image associated with the second entity and editable by the second entity, also including a shared items group customized by the second entity for the first entity as a function of one or more files transferred to the first entity from the second entity.

19. The graphical user interface of claim 18, wherein the electronic communication application is configured to send and receive email messages through an electronic communication channel.

20. The graphical user interface of claim 18, comprising a component that graphically renders the interactive profile of the second entity in an
